(19) United States
(12) Patent Application Publication
(10) Pub. No.: US 2025/0328956 A1
(43) Pub. Date: Oct. 23, 2025

(54) Technologies for Real-Time Customer Position Determination

(71) Applicant: The PNC Financial Services Group, Inc., Pittsburgh, PA (US)

(72) Inventors: Venkataraman Muthuramalingam, Farmers Branch, TX (US); Devesh Kumar Pandey, Cleveland, OH (US); Vijayapal Reddi Morthala, Tampa, FL (US); Burkhardt Reiter, Pittsburgh, PA (US)

(21) Appl. No.: 19/023,638

(22) Filed: Jan. 16, 2025

Related U.S. Application Data
(60) Provisional application No. 63/636,954, filed on Apr. 22, 2024.

(51) Int. Cl. G06Q 40/03

(52) U.S. Cl. CPC G06Q 40/03

(57) ABSTRACT

Technologies for real-time position determination include a compute device. The compute device includes circuitry configured to obtain, by aggregating multiple data streams of an event streaming system, financial status data indicative of balances and transactions associated with financial accounts of a customer of a financial institution. The circuitry may additionally be configured to determine, based on the obtained financial status data, a financial position indicative of a consolidation of the financial status data for the customer of the financial institution. Further, the circuitry may be configured to provide a user interface indicative of the financial position of the customer.

### RELATED APPLICATIONS

This application claims the benefit of U.S. Provisional Application 63/636,954 filed Apr. 22, 2024 for “Technologies for Real-Time Position Determination,” which is hereby incorporated by reference in its entirety.

### BACKGROUND

Financial institutions, such as banks, may provide a multitude of financial products to customers to enable customers to borrow money, invest, and conduct financial transactions through a variety of different payment systems (e.g., credit card payment networks, digital payment networks, an automated clearing house network, etc.). As such, any given customer may have a complex set of activities spanning multiple financial accounts. For a financial institution, understanding how a given customer is positioned in terms of their activities across the multiple accounts pertaining to multiple financial products is a significant technical challenge. That is, due to technical limitations in conventional banking systems, when attempting to determine whether to extend credit to the customer, approve the customer for a loan, or offer another type of financial product to the customer, the available data to inform such a decision is often delayed by a month or more, may pertain to only a subset of financial products that the customer is involved in, and cannot be readily understood in a comprehensive manner by a human.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for continually determining financial positions of customers of a financial institution;

FIG. 2 is a simplified block diagram of at least one embodiment of a compute device of the system of FIG. 1;

FIGS. 3-7 are simplified block diagrams of at least one embodiment of a method for determining financial positions of customers of a financial institution that may be executed by the system of FIG. 1;

FIGS. 8-9 are diagrams of embodiments of data flows that may be utilized by the system of FIG. 1 in determining financial positions of customers; and

FIGS. 10-12 are diagrams of embodiments of user interfaces that may be produced by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

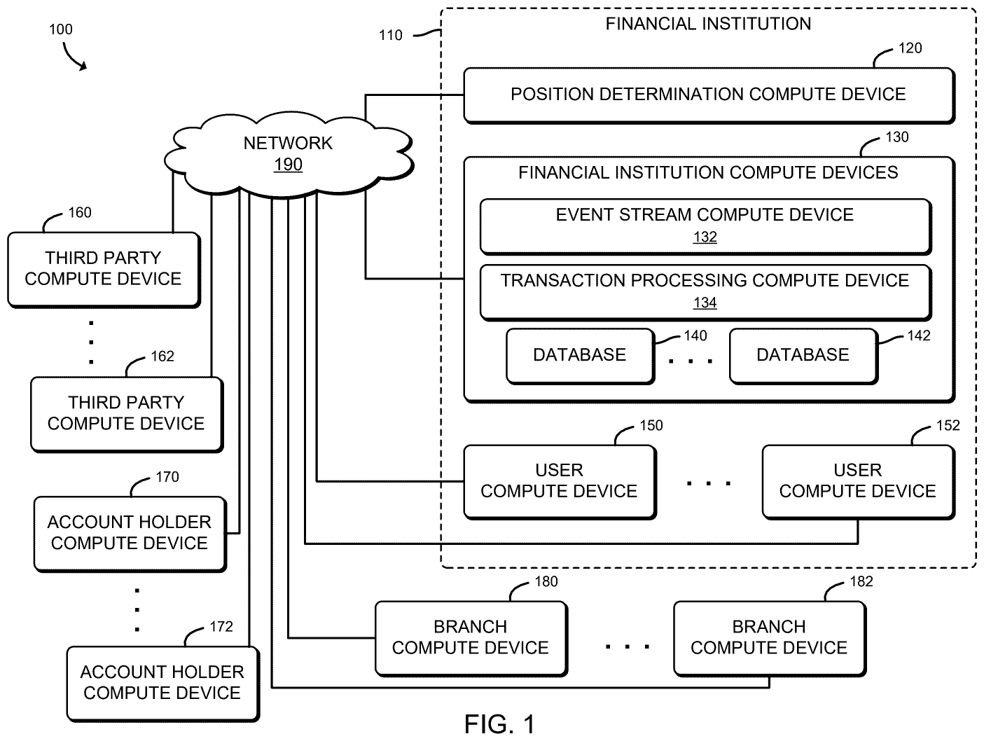

Referring now to FIG. 1, a system 100 for continually determining the financial positions of customers (e.g., account holders) associated with a financial institution 110 includes, in the illustrative embodiment, a position determination compute device 120 communicatively connected to a set of one or more financial institution compute devices 130. The financial institution compute devices 130 include an event stream compute device 132 which receives, from other compute devices (e.g., one or more transaction processing compute devices 134), sets of data pertaining to the operations of the financial institution 110, including inflows (e.g., deposits), outflows (e.g., withdrawals, payments), purchases and/or sales of investments, maturities, approvals for loans, approvals for credit, and the like occurring in connection with accounts associated with the financial institution 110. Transactions associated with financial accounts of customers of the financial institution 110 may be initiated or processed in part by third party compute devices 160, 162, such as e-commerce platforms, merchants, components of payment networks (e.g., gateways, point of sale devices, etc.), and the like. Those third party compute devices 160, 162 may interact with the financial institution compute devices 130 to complete the transactions. Likewise, account holder compute devices 170, 172 may interact with the third party compute devices 160, 162 (e.g., to make purchases) and/or the financial institution compute devices 130 (e.g., to view account information, initiate financial transactions, apply for financial products such as loans or credit cards, etc.). Branch compute devices 180, 182, which may be embodied as any compute devices associated with physical branch offices of the financial institution 110, may initiate financial transactions based on in-person interactions with customers at the physical branch locations. The compute devices 120, 130 may utilize databases 140, 142 which may enable storage and retrieval of data (e.g., customer account identifiers, data indicative of financial products, records of financial transactions, etc.), on as requested basis, to enable the financial institution 110 to carry out operations described herein.

In operation, the event stream compute device 132 enables compute devices, such as the position determination compute device 120, to receive continual streams of data associated with topics (e.g., identifiers, such as keywords) by subscribing to those streams. In at least some embodiments, the event stream compute device 132 may be implemented in accordance with the event backbone and streaming processor described in U.S. Pat. No. 11,507,438, incorporated by reference herein. The data streams are based on data produced by other compute devices (e.g., one or more transaction processing compute devices 134) and associated with topics on a continual basis as financial transactions are processed. Those data streams, unlike batches in which data is collected and provided to other compute devices on a periodic basis (e.g., nightly, weekly, etc.), are disseminated to other compute devices (e.g., the position determination compute device 120) on an ongoing basis, representing events as they occur. As such, in the illustrative embodiment, the data that the position determination compute device 120 obtains from the one or more streams is real-time data (e.g., representative of events as they are occurring).

The position determination compute device 120, in operation, obtains and aggregates financial status data which may be indicative of balances and transactions associated with financial accounts (e.g., accounts associated with checking, savings, certificates of deposit, loans, credit, etc.) of customers of the financial institution 110 and determines, for a given customer, a financial condition, based on the obtained financial status data. The financial condition represents a consolidation of the customer's financial statuses across their financial accounts and may indicate the customer's financial health, including creditworthiness, risks, and/or spending, saving, and/or investing behaviors. Further, in the illustrative embodiment, the position determination compute device 120 provides a user interface that represents a customer's financial position to enable a human operator to efficiently determine whether a customer should be approved for a loan or credit, what risks may be associated with the customer (e.g., risk of default), and/or what products of the financial institution 110 would suit the customer based on the customer's determined behaviors. Importantly, unlike conventional systems, the data utilized by the position determination compute device 120 to perform the operations is vastly superior to data that may be available in conventional systems. That is, in determining and presenting a customer's financial position, the position determination compute device 120 does so based on a comprehensive view of real-time data (e.g., representing events as they occur) as well as historical data across a multitude of financial products, thereby enabling personnel associated with the financial institution 110 (e.g., at a branch, using a branch compute device 180, 182 or at a call center at the financial institution 110, using one or more user compute devices 150, 152) to make significantly more informed decisions to better serve customers and to manage risk for the financial institution 110.

While relatively few compute devices 120, 130, 132, 134, 150, 152, 160, 162, 170, 172, 180, 182 are shown in FIG. 1 for simplicity and clarity, it should be understood that the number of compute devices, in practice, may range in the tens, hundreds, thousands, or more. Likewise, it should be understood that the compute devices 120, 130, 132, 134, 150, 152, 160, 162, 170, 172, 180, 182 may be distributed differently or perform different roles than the configuration shown in FIG. 1. Further, though shown as separate compute devices 120, 130, 132, 134, 150, 152, 160, 162, 170, 172, 180, 182 in some embodiments, the functionality of one or more of the compute devices 120, 130, 132, 134, 150, 152, 160, 162, 170, 172, 180, 182 may be combined into fewer compute devices (the position determination compute device 120 may be combined with the financial institution compute device(s) 130) and/or distributed across more compute devices than those shown in FIG. 1 (e.g., the position determination compute device 120 may comprise multiple compute devices and/or the financial institution compute devices 130 may comprise any number of compute devices).

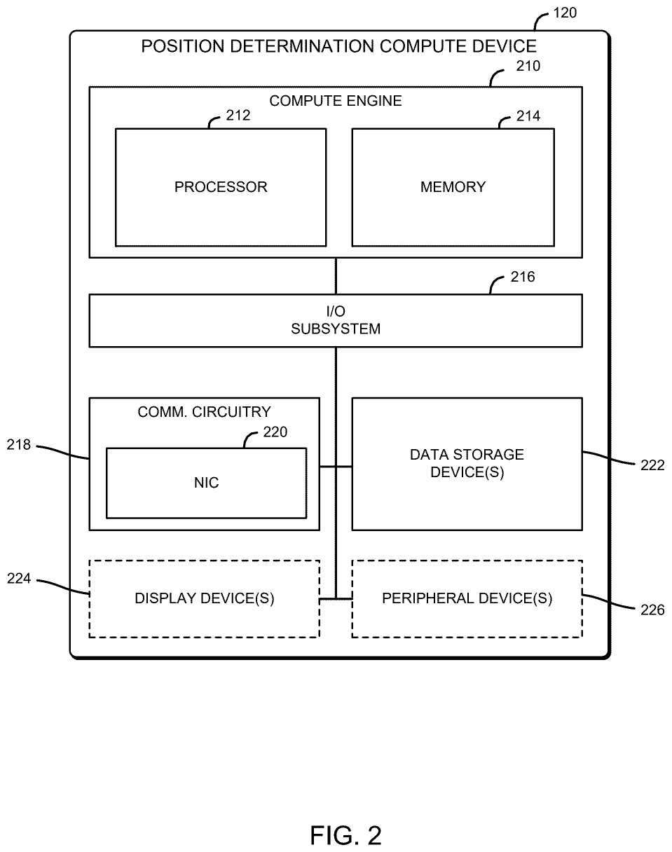

Referring now to FIG. 2, the illustrative position determination compute device 120 includes a compute engine 210, an input/output (I/O) subsystem 216, communication circuitry 218, and one or more data storage devices 222. In some embodiments, the position determination compute device 120 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the position determination compute device 120 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as financial status data, financial position data, applications, libraries, and drivers.

The compute engine 210 is communicatively coupled to other components of the position determination compute device 120 via the I/O subsystem 216, which may be embodied as circuitry and/or components to facilitate input/output operations with the compute engine 210 (e.g., with the processor 212 and the main memory 214) and other components of the position determination compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the position determination compute device 120, into the compute engine 210.

The communication circuitry 218 may be embodied as any communication circuit, device, or collection thereof, capable of enabling communications over a network between the position determination compute device 120 and another device (e.g., a compute device 130, 132, 134, 150, 152, 160, 162, 170, 172, 180, 182, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the position determination compute device 120 to connect with another compute device (e.g., a compute device 130, 132, 134, 150, 152, 160, 162, 170, 172, 180, 182, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the position determination compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the position determination compute device 120 are housed in a single unit. However, in other embodiments, the components may be in separate housings, in separate racks of a data center, and/or spread across multiple data centers or other facilities. The compute devices 130, 132, 134, 150, 152, 160, 162, 170, 172, 180, 182 may have components similar to those described in FIG. 2 with reference to the position determination compute device 120. The description of those components of the position determination compute device 120 is equally applicable to the description of components of the compute devices 130, 132, 134, 150, 152, 160, 162, 170, 172, 180, 182. Further, it should be appreciated that any of the devices 120, 130, 132, 134, 150, 152, 160, 162, 170, 172, 180, 182 may include other components, sub-components, and devices commonly found in a computing device, which are not discussed above in reference to the position determination compute device 120 and not discussed herein for clarity of the description.

In the illustrative embodiment, the compute devices 120, 130, 132, 134, 150, 152, 160, 162, 170, 172, 180, 182, are in communication via a network 190, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

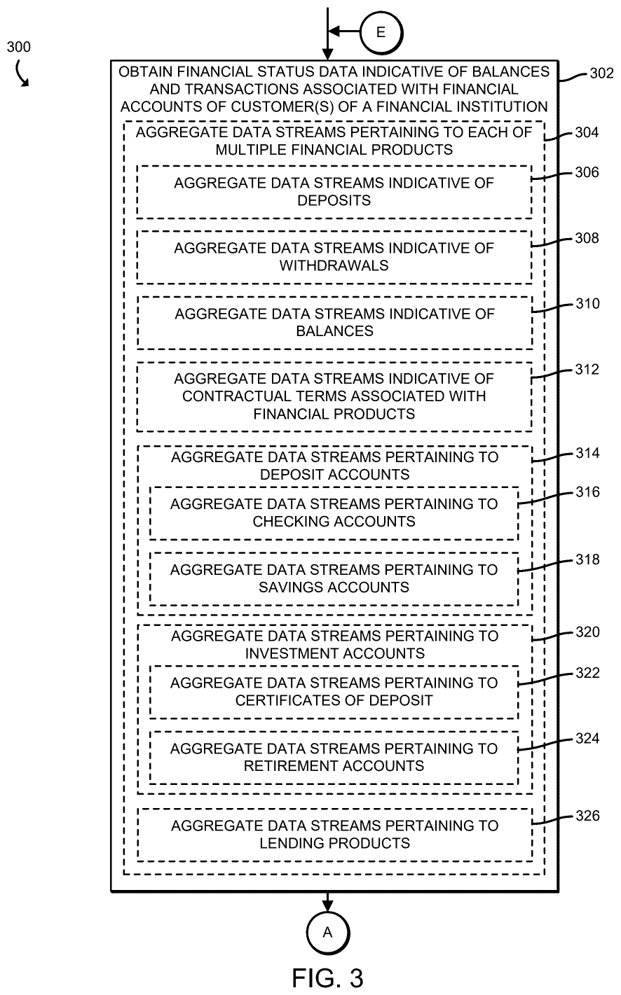

Referring now to FIG. 3, the system 100, and specifically, the position determination compute device 120, in the illustrative embodiment, may perform a method 300 for determining the present financial positions of customers of a financial institution (e.g., the financial institution 110) to enable the financial institution to make more informed decisions regarding how to serve and manage risk associated with those customers. The method 300 begins with block 302 in which the position determination compute device 120 obtains financial status data, which may be embodied as any data indicative of balances and transactions associated with financial accounts of customers of a financial institution (e.g., the financial institution 110). In doing so, the position determination compute device 120, in the illustrative embodiment, aggregates data streams pertaining to each of multiple financial products, as indicated in block 304. The position determination compute device 120, in the illustrative embodiment, aggregates financial status data with (e.g., using) an event streaming system (e.g., the event stream compute device 132) in which events are associated with one or more topics that are available for subscription.

As indicated in block 306, the position determination compute device 120 may aggregate data streams indicative of deposits (e.g., to financial accounts associated with the financial institution). Likewise, and as indicated in block 308, the position determination compute device 120 may aggregate data streams that are indicative of withdrawals (e.g., from financial accounts associated with the financial institution 110). The position determination compute device 120 may aggregate data streams indicative of balances of financial accounts associated with the financial institution 110, as indicated in block 310. In some embodiments, a given data stream may indicate more than one type of information. That is, in some embodiments, the same data stream may indicate one or more of deposits, withdrawals, or balances for a given financial product or financial account. The position determination compute device 120 may also aggregate data streams indicative of contractual terms (e.g., interest rates, payment schedules, etc.) associated with one or more financial products (e.g., lending products, credit products, etc.), as indicated in block 312. In some embodiments, a data stream may indicate the contractual terms by referring to a financial product (e.g., by an identification code) and the contractual terms may be defined in a database 140, 142 in connection with that financial product.

Still referring to FIG. 3, the position determination compute device 120 may aggregate data streams pertaining to deposit accounts, as indicated in block 314. In doing so, the position determination compute device 120 may aggregate data streams pertaining to checking accounts, as indicated in block 316 and/or savings accounts, as indicated in block 318. Additionally or alternatively, the position determination compute device 120 may aggregate data streams pertaining to investment accounts, as indicated in block 320. In doing so, the position determination compute device 120 may aggregate data streams pertaining to certificates of deposit, as indicated in block 322 and/or retirement accounts, as indicated in block 324. In other embodiments, the position determination compute device 120 may aggregate data streams associated with other investment accounts (e.g., brokerage accounts, etc.). The position determination compute device 120 may aggregate data streams pertaining to lending products, as indicated in block 326. In doing so, the position determination compute device 120 may aggregate data streams pertaining to auto (e.g., vehicle) loans, business loans, personal loans, mortgages, home equity loans, and/or other loans.

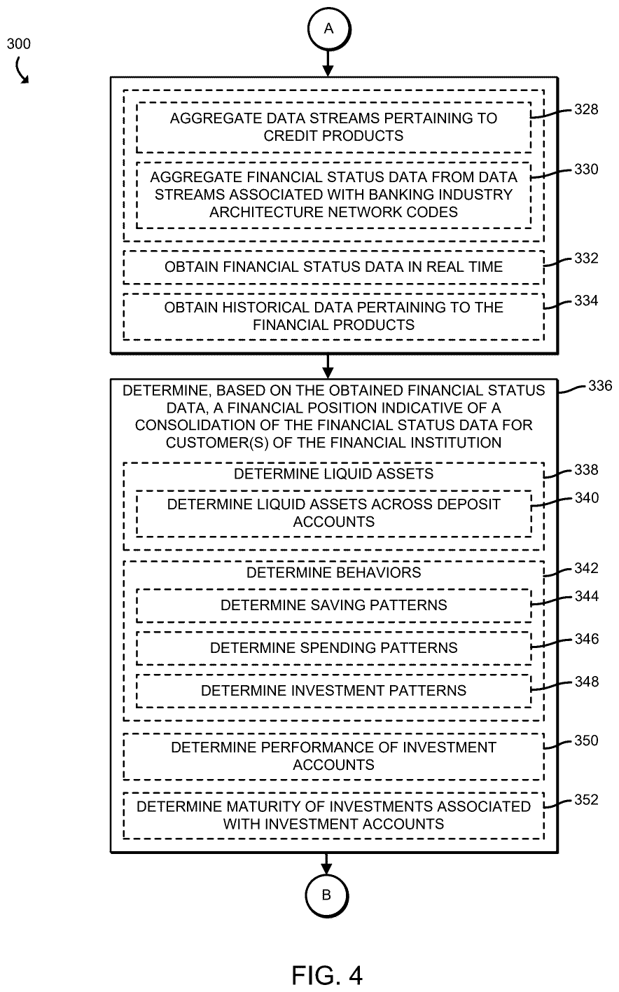

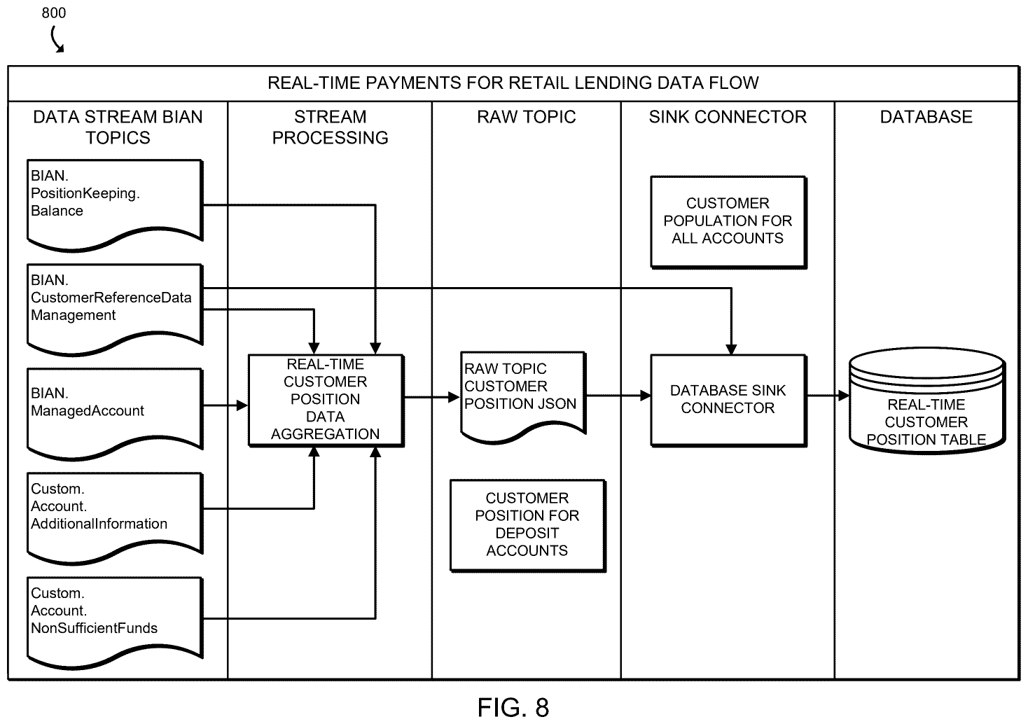

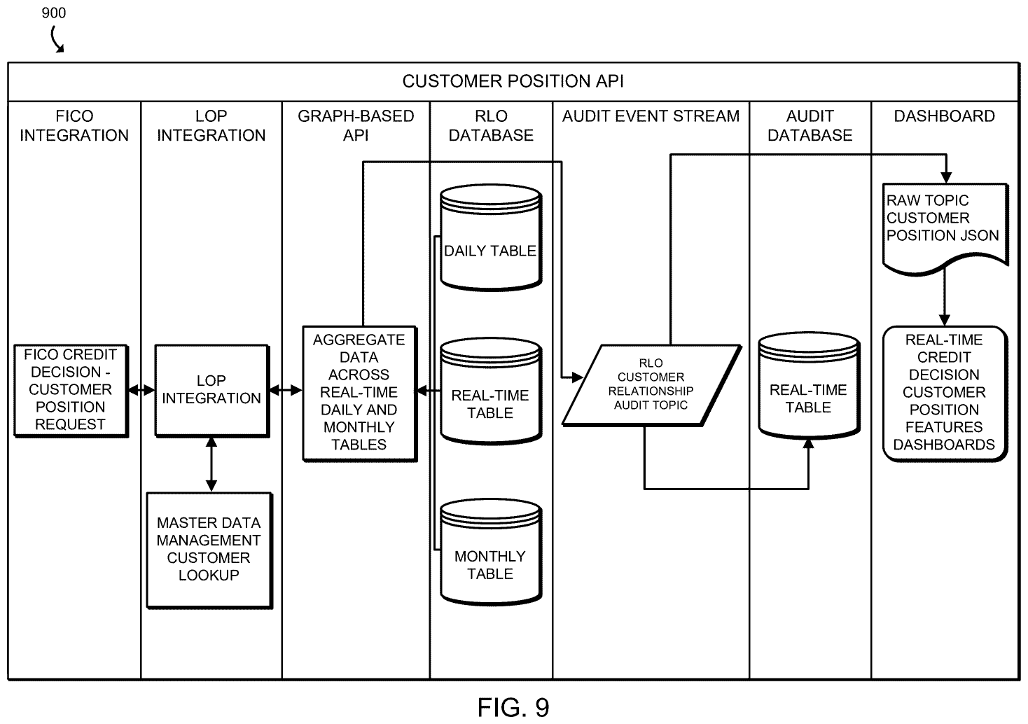

Continuing the method 300, as indicated in block 328 of FIG. 4, the position determination compute device 120 may aggregate data streams pertaining to credit products (e.g., credit cards). The position determination compute device 120 may aggregate the financial status data from data streams that are associated with banking industry architecture network (BIAN) codes, as indicated in block 330. For example, and as indicated in the data flow 800 of FIG. 8, the position determination compute device 120 may subscribe to the following topics to obtain and aggregate corresponding data streams: “BIAN.PositionKeeping.Balance” (e.g., indicative of the balance of a financial account), “BIAN.CustomerReferenceDataManagement” (e.g., indicative of data regarding the customer associated with a given financial account), and “BIAN.ManagedAccount” (e.g., indicative of the financial account to which a balance pertains). The position determination compute device 120 may also subscribe to the following topics for corresponding data streams: “Custom.Account.AdditionalInformation” (e.g., indicative of expansive information regarding the type of financial product to which the financial account pertains) and “Custom.Account.NonSufficientFunds” (e.g., indicative of whether financial transactions have been rejected due to lack of sufficient funds for the corresponding financial account). Referring briefly to FIG. 9, the diagram 900 illustrates an embodiment of a data flow among databases and application programming interfaces (APIs) that may be utilized in the system 100 to determine customer financial positions and ultimately present a corresponding user interface (e.g., dashboard) to graphically represent data associated with customer financial positions. As indicated in block 332, the position determination compute device 120 obtains the financial status data in real time (e.g., as events pertaining to the accounts occur), by virtue of receiving corresponding data streams via the event stream compute device 132, rather than obtaining batches of the data on a periodic basis (e.g., daily, weekly, monthly, etc.). As indicated in block 334, the position determination compute device 120 may obtain historical data pertaining to the financial products (e.g., from one or more of the databases 140, 142). The historical data may be indicative of the above information (e.g., deposits, withdrawals, balances, etc.) over a past (e.g., already-elapsed) time period.

Continuing the method 300, in the illustrative embodiment, the position determination compute device 120 determines, based on the obtained financial status data (e.g., from block 302), a financial position, as indicated in block 336. The financial position may be embodied as any data indicative of a consolidation of the financial status data for customers of the financial institution 110. That is, the financial position data is a consolidation of financial status data on a per customer basis (e.g., for each customer, a consolidation of financial status data across the accounts associated with that customer). In determining the financial position of a given customer, the position determination compute device 120, in the illustrative embodiment, determines the liquid assets of the customer, as indicated in block 338. The position determination compute device 120 may do so by determining the liquid assets across deposit accounts (e.g., checking accounts, savings accounts, etc.) associated with the customer, as indicated in block 340. The position determination compute device 120, in the illustrative embodiment, also determines one or more behaviors of a customer based on the financial status data, as indicated in block 342. In doing so, the position determination compute device 120 may determine savings patterns (e.g., an amount per month that the customer deposits into a savings account, a percentage of the customer's income that the customer deposits into a savings account, etc.), as indicated in block 344. Additionally or alternatively, the position determination compute device 120 may determine spending patterns of the customer, as indicated in block 346. In doing so, the position determination compute device 120 may determine what percentage of the customer's income is spent on purchases, the frequency and relative size of purchases (e.g., frequent small purchases, periodic large purchases), and/or the types of goods or services purchased (e.g., as indicated, for example, by identifiers of merchants with which the customer makes purchases).

The position determination compute device 120 may also determine investment patterns of a customer, as indicated in block 348. In doing so, the position determination compute device 120 may identify the types of investments and time span over which the customer appears to be orienting their investments. For example, the position determination compute device 120 may determine whether the customer is primarily investing in aggressive growth assets that present a higher likelihood of volatility (e.g., sudden changes in value) over a relatively short time span or slower growth assets that present less risk of volatility. The position determination compute device 120 may determine whether the customer has a preference for assets that provide income (e.g., via dividends) versus assets that are oriented towards increasing price per share. Similarly, and as indicated in block 350, the position determination compute device 120 may determine the performance of investment accounts associated with the customer (e.g., amount of money produced by the investments over a defined time period relative to the amount of money paid by the customer for the investments). The position determination compute device 120 may also determine the maturity of investments associated with investment accounts of a customer, as indicated in block 352. For example, the position determination compute device 120 may determine the contractually defined date on which the customer will receive payments associated with one or more of their investments, such as repayment of their principal along with interest or dividends, and the amount of time remaining before that maturity date.

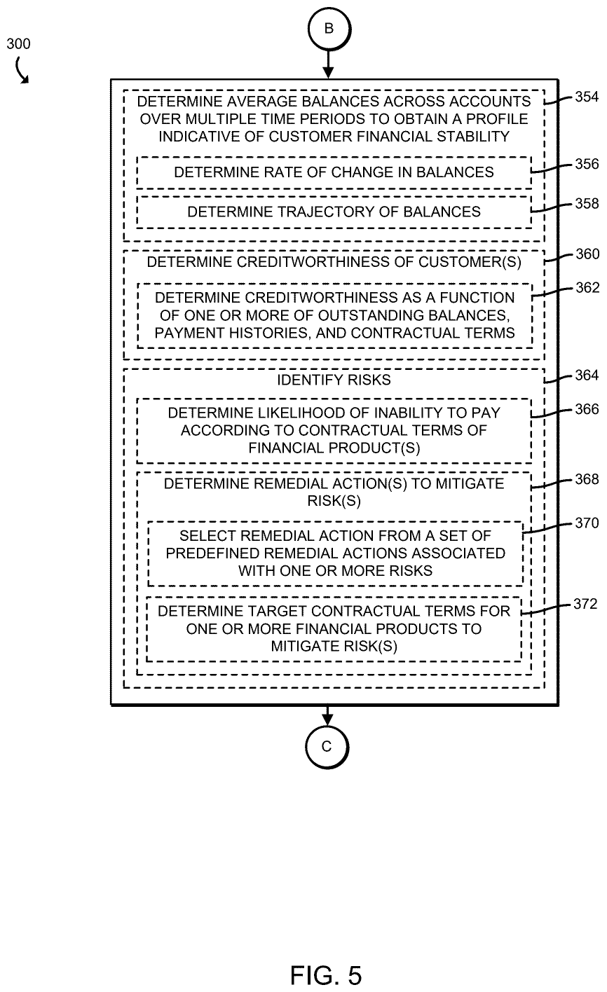

Referring now to FIG. 5, the position determination compute device 120 may determine average balances across financial accounts for a given customer over multiple time periods, to obtain a profile indicative of the customer's financial stability, as indicated in block 354. In doing so, the position determination compute device 120 may determine a rate of change in the balances (e.g., percentage change in the balances over a defined time period), as indicated in block 356. The position determination compute device 120 may also determine a trajectory of the balances (e.g., whether they are increasing or decreasing over time, an estimated amount of time until the balances reach a target value, etc.), as indicated in block 358. In some embodiments, the position determination compute device 120 may determine the creditworthiness of a customer (e.g., an indication of determined risk in providing financial credit to the customer), as indicated in block 360. As indicated in block 362, the position determination compute device 120 may determine the creditworthiness as a function of (e.g., based on) one or more of outstanding balances across the financial accounts, payment histories, and/or contractual terms of financial products associated with the customer. For example, if the contractual terms associated with a credit card indicate a monthly balance due date and the customer has a payment history indicating consistent payment of the balance due by the defined balance due date, the position determination compute device 120 may determine that the customer has better creditworthiness than if the payment history indicates inconsistencies in paying the balance due by the due date. As another example, the position determination compute device 120 may determine that lower outstanding balances on financial products associated with the customer represent a lower debt load and as such, the customer may be able to take on more debt than if the outstanding balances were higher. In determining the credit worthiness, the position determination compute device 120 may provide financial status data (e.g., the outstanding balances, payment histories, and contractual terms) to one or more machine learning models trained to determine a corresponding creditworthiness, a set of defined rules (e.g., business rules) for determining creditworthiness, and/or a combination thereof.

The position determination compute device 120 may identify one or more risks associated with a given customer, as indicated in block 364 of FIG. 5. In doing so, the position determination compute device 120 may determine a likelihood of an inability to pay according to contractual terms of one or more financial products, as indicated in block 366. That is, if the customer appears to have insufficient funds in their balance to pay by a defined due date and, based on a history of deposits to their deposit accounts, it does not appear that the customer will have a sufficient deposit to a financial account to cover the amount due by the due date, the position determination compute device 120 may identify a risk that the customer will be unable to pay according to the contractual terms of the corresponding financial product. The position determination compute device 120 may determine one or more remedial actions to mitigate any identified risks, as indicated in block 368. In doing so, the position determination compute device 120 may select a remedial action from a set of predefined remedial actions (e.g., defined in a database 140, 142) associated with one or more corresponding risks (e.g., an inability to pay an amount due on a loan or by the defined due date), as indicated in block 370. As indicated in block 372, the position determination compute device 120 may determine a set of target contractual terms for one or more financial products (e.g., a loan) to mitigate the identified risk(s). Continuing the example, the position determination compute device 120 may determine that a loan with smaller payments over a longer time period (e.g., selected from a database 140, 142 of financial products and corresponding contractual terms) would reduce the risk of the customer missing the payment or defaulting on the existing loan.

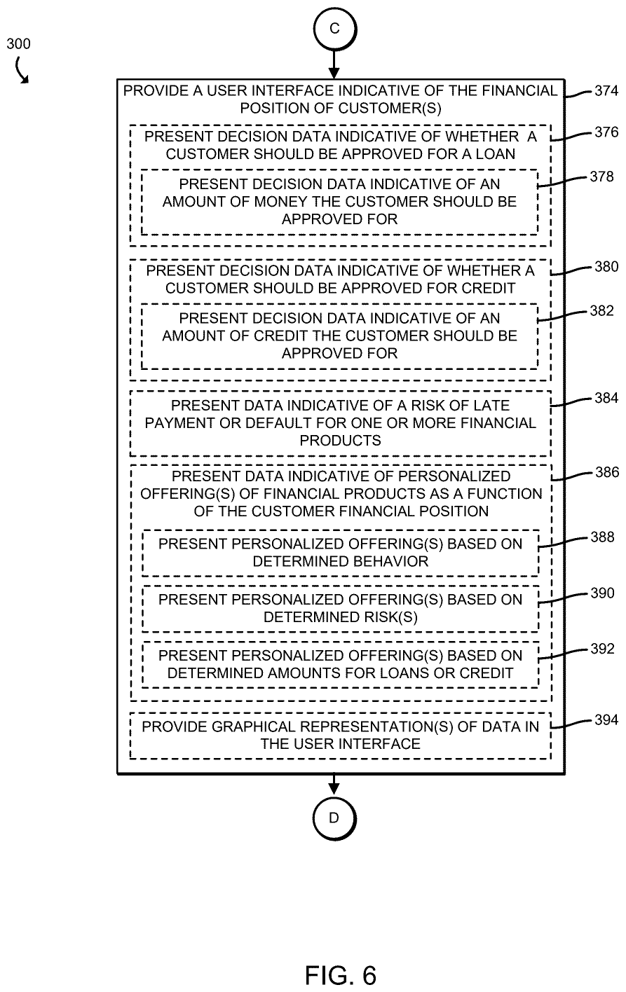

Referring now to FIG. 6, in the illustrative embodiment, the position determination compute device 120 provides a user interface indicative of the financial position of a given customer (e.g., by sending data and/or instructions, such as hyper-text markup language (HTML) code, JavaScript code, cascading style sheet(s), and image data, defining the user interface to a device capable of rendering the user interface), as indicated in block 374. The following description of pertains to a single customer (e.g., for which the position determination compute device 120 determined a financial position). However, it should be understood that the position determination compute device 120 may perform the operations for any number of customers for which the position determination compute device 120 determined a corresponding financial position. In presenting a user interface, the position determination compute device 120 may present decision data indicative of whether a customer should be approved for a loan (e.g., to assist a person working at a branch office or at a call center in determining whether to approve a customer for a loan), as indicated in block 376. The position determination compute device 120 may present decision data that is additionally indicative of the amount of money the customer should be approved for (e.g., for a loan), as indicated in block 378. Similarly, and as indicated in block 380, the position determination compute device 120 may present decision data indicative of whether a customer should be approved for credit. Further, the position determination compute device 120 may present decision data indicative of the amount of credit that the customer should be approved for (e.g., based on the determined creditworthiness from block 360), as indicated in block 382. In some embodiments, rather than providing the user interface to a branch compute device 180, 182 (e.g., to assist a person working at a branch office) or to a user compute device 150, 152 (e.g., to assist a person working at a call center of the financial institution 110), the position determination compute device 120 may provide the decision data in a user interface presented to the customer (e.g., with an account holder compute device 170, 172), thereby directly informing the customer whether and how much money they can borrow or credit they can receive through a corresponding financial product of the financial institution 110.

The position determination compute device 120 may present data indicative of one or more risks identified for the customer (e.g., from block 364), such as a risk of late payment or default for one or more financial products, as indicated in block 384. The position determination compute device 120 may present data indicative of one or more personalized offerings of one or more financial products as a function of (e.g., based on) the customer's financial position (e.g., determined in block 336), as indicated in block 386. In doing so, the position determination compute device 120 may present one or more personalized offerings based on the determined behavior of the customer, as indicated in block 388. Additionally or alternatively, the position determination compute device 120 may present one or more personalized offers based on determined risks associated with the customer, as indicated in block 390. The position determination compute device 120 may present one or more personalized offerings based on determined amounts for loans and/or credit, as indicated in block 392. Accordingly, the position determination compute device 120 may present personalized offers for credit cards, personal loans, auto loans, mortgages, business loans, investments for short term growth, investments for long term growth (e.g., retirement), and/or adjusted versions of financial products that the customer already uses (e.g., adjusted terms on a loan, such as a longer term with smaller monthly payments). In the illustrative embodiment, the position determination compute device 120 provides one or more graphical representations of data in the user interface (e.g., the user interface is a graphical user interface), as indicated in block 394. By providing a graphical representation of the data, rather than merely providing plain text or numbers, the position determination compute device 120 enables a viewer to more readily understand trends or patterns identified by the position determination compute device 120 in the data.

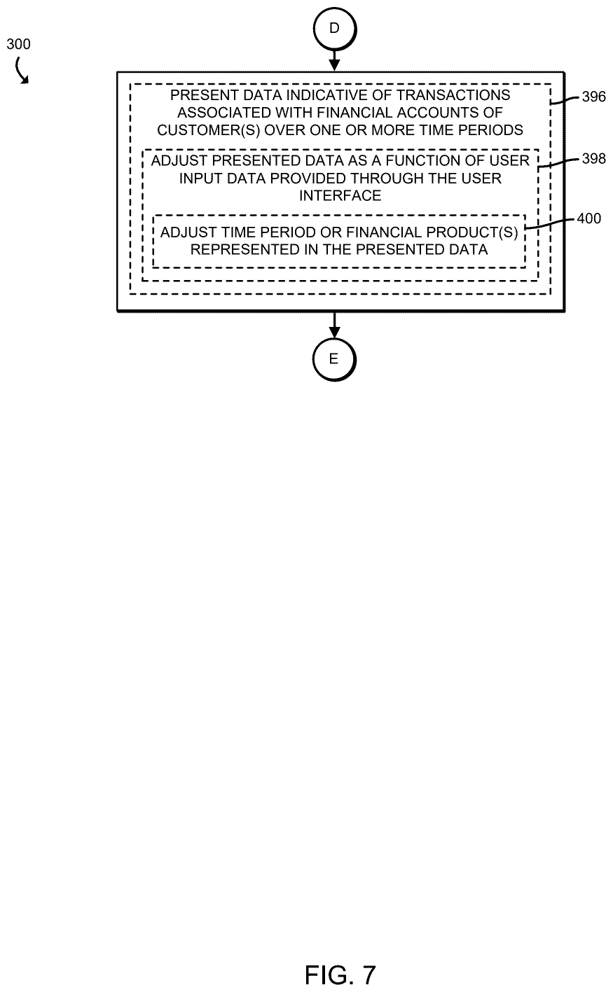

Referring now to FIG. 7, the position determination compute device 120 may present data indicative of transactions associated with one or more financial accounts of a customer over one or more time periods, as indicated in block 396. Further, the position determination compute device 120 may adjust the presented data as a function of user input data (e.g., selection of a user interface element, a selection of a menu item, text entered in a corresponding text box, etc.) provided through the user interface (e.g., as indicated by a corresponding API call, such as a REST API call, sent by the compute device 150, 152, 170, 172, 180, 182 associated with the user of the user interface (a branch employee, a call center employee, the customer)), as indicated in block 398. In doing so, and as indicated in block 400, the position determination compute device 120 may adjust the time period or set of financial products represented in the presented data (e.g., by sending corresponding data and/or instructions, such as HTML, JavaScript, CSS, and/or image data for use in rendering the updated user interface).

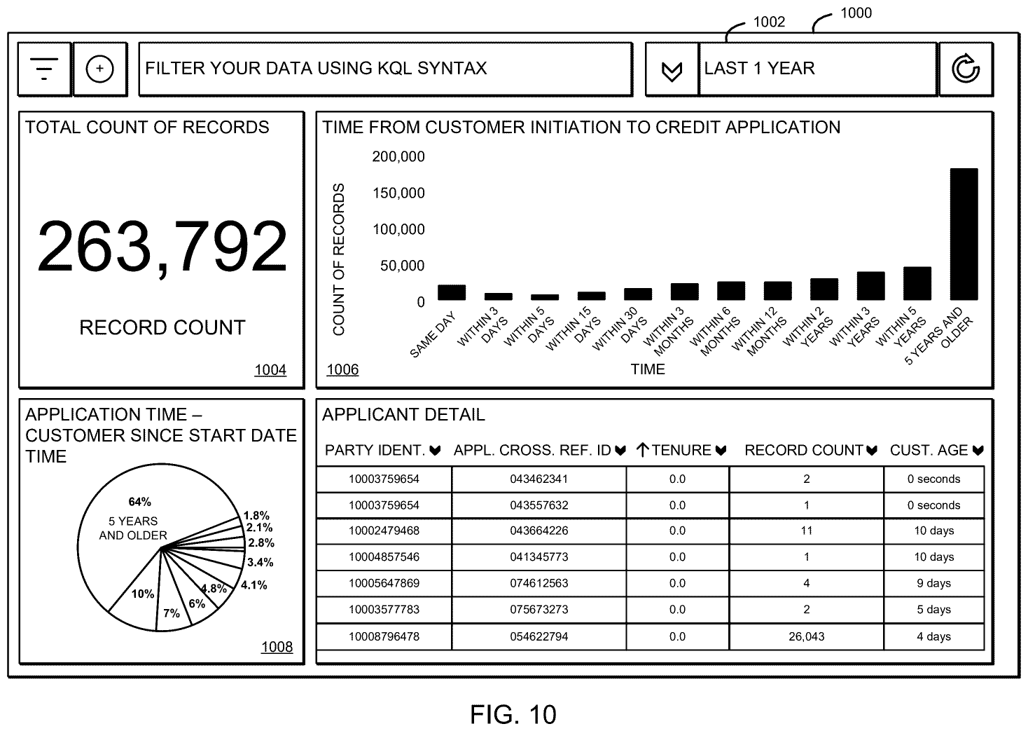

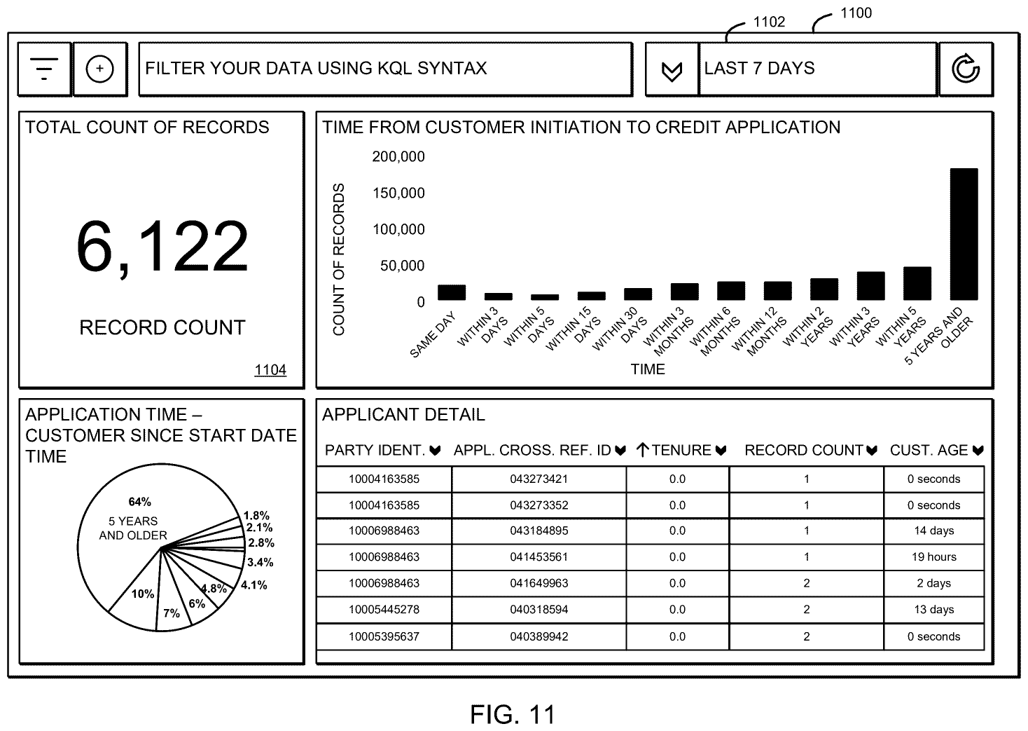

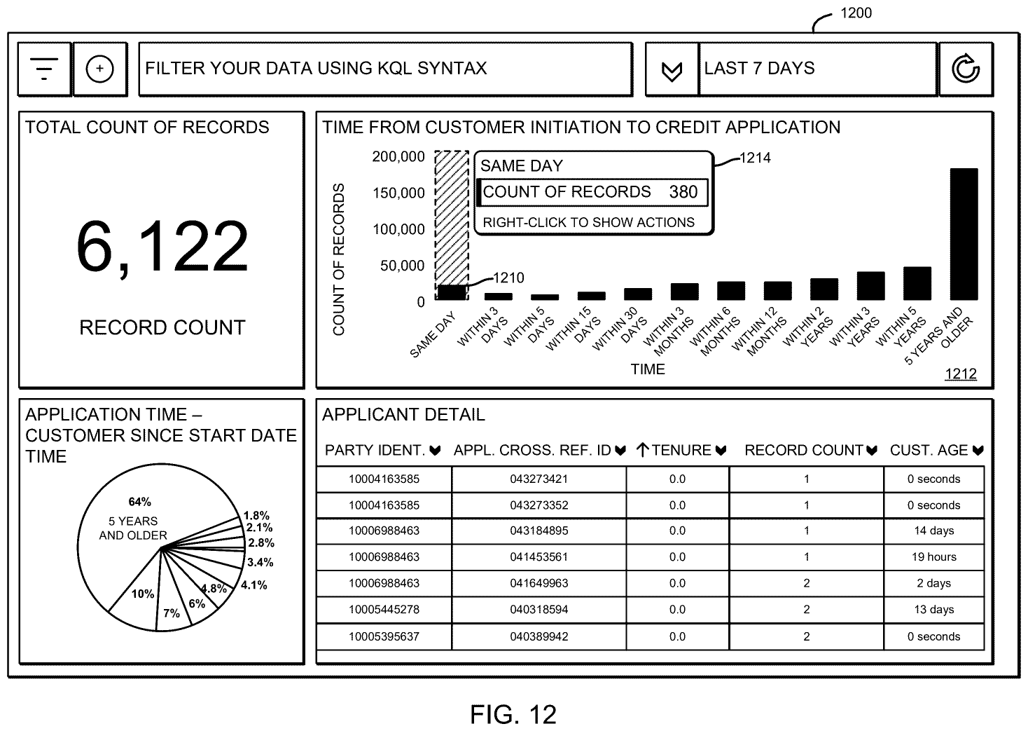

Referring briefly to FIG. 10, an embodiment of a user interface 1000 that may be provided by the position determination compute device 120 based on the operations of the method 300 includes multiple graphical representations 1006, 1008 of transactions associated with credit applications over varying time periods. In response to receiving user input through a user interface element 1002, 1102 in which the user changed the time period from one year to the previous seven days, the position determination compute device 120 updates certain information (e.g., total count of records 1004, 1104), as reflected in the updated user interface 1100 of FIG. 11. Referring briefly to the user interface 1200 in FIG. 12, the position determination compute device 120 may receive user input indicating that a user has selected an element such as a bar 1210 in a bar graph 1212, and may present contextual information (e.g., the specific number represented by the bar 1210) and options associated with the selection, as shown in the pop-up window 1214. By providing an interactive graphical user interface that represents a compilation of real-time and historical financial status data (e.g., into financial position data) across a significant range of financial accounts and financial products, the position determination compute device 120 enables determinations to be made regarding management of risk for both the customer and the financial institution 110 much more efficiently than would be possible with conventional systems.

In the illustrative embodiment, the method 300 loops back to block 302 of FIG. 3 to obtain additional financial status data. Though the operations of the method 300 are described in a particular sequence, it should be understood that in other embodiments, operations may be performed in a different order and/or in parallel (e.g., obtaining additional financial status data while determining financial positions and providing a corresponding user interface). While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain, by aggregating multiple data streams of an event streaming system, financial status data indicative of balances and transactions associated with financial accounts of a customer of a financial institution; determine, based on the obtained financial status data, a financial position indicative of a consolidation of the financial status data for the customer of the financial institution; and provide a user interface indicative of the financial position of the customer.

Example 2 includes the subject matter of Example 1, and wherein to obtain financial status data comprises to obtain financial status data in real time.

Example 3 includes the subject matter of any of Examples 1 and 2, and wherein to obtain financial status data comprises to aggregate data streams indicative of deposits, withdrawals, and balances associated with one or more of the financial accounts of the customer.

Example 4 includes the subject matter of any of Examples 1-3, and wherein to obtain financial status data comprises to obtain data indicative of contractual terms associated with one or more of the financial accounts.

Example 5 includes the subject matter of any of Examples 1-4, and wherein to obtain financial status data comprises to aggregate data streams pertaining to one or more deposit accounts of the customer.

Example 6 includes the subject matter of any of Examples 1-5, and wherein to obtain financial status data comprises to aggregate data streams pertaining to one or more checking accounts or savings accounts of the customer.

Example 7 includes the subject matter of any of Examples 1-6, and wherein to obtain financial status data comprises to aggregate data streams pertaining to one or more investment accounts of the customer.

Example 8 includes the subject matter of any of Examples 1-7, and wherein to obtain financial status data comprises to aggregate data streams pertaining to one or more certificates of deposit or retirement accounts of the customer.

Example 9 includes the subject matter of any of Examples 1-8, and wherein to obtain financial status data comprises to aggregate data streams pertaining to one or more lending products of the financial institution.

Example 10 includes the subject matter of any of Examples 1-9, and wherein to obtain financial status data comprises to aggregate data streams pertaining to one or more credit products of the financial institution.

Example 11 includes the subject matter of any of Examples 1-10, and wherein to obtain financial status data comprises to aggregate data streams associated with banking industry architecture network codes.

Example 12 includes the subject matter of any of Examples 1-11, and wherein to obtain financial status data comprises to obtain historical data pertaining to financial products of the financial institution.

Example 13 includes the subject matter of any of Examples 1-12, and wherein to determine a financial position comprises to determine liquid assets of the customer.

Example 14 includes the subject matter of any of Examples 1-13, and wherein to determine a financial position comprises to determine one or more behaviors of the customer based on the obtained financial status data.

Example 15 includes the subject matter of any of Examples 1-14, and wherein to determine one or more behaviors comprises to determine one or more of saving patterns, spending patterns, or investment patterns of the customer.

Example 16 includes the subject matter of any of Examples 1-15, and wherein to determine a financial position comprises to determine a performance of one or more investment accounts of the customer.

Example 17 includes the subject matter of any of Examples 1-16, and wherein to determine a financial position comprises to determine a maturity of one or more investments associated with one or more investment accounts of the customer.

Example 18 includes the subject matter of any of Examples 1-17, and wherein to determine a financial position comprises to determine average balances across financial accounts of the customer over multiple time periods to obtain a profile indicative of a financial stability of the customer.

Example 19 includes the subject matter of any of Examples 1-18, and wherein to obtain a profile indicative of the financial stability comprises to determine a rate of change in balances across the financial accounts of the customer.

Example 20 includes the subject matter of any of Examples 1-19, and wherein to obtain a profile indicative of the financial stability comprises to determine a trajectory of balances across the financial accounts of the customer.

Example 21 includes the subject matter of any of Examples 1-20, and wherein to determine a financial position comprises to determine a creditworthiness of the customer.

Example 22 includes the subject matter of any of Examples 1-21, and wherein to determine the creditworthiness of the customer comprises to determine the creditworthiness as a function of outstanding balances, payment histories, and contractual terms of financial products used by the customer.

Example 23 includes the subject matter of any of Examples 1-22, and wherein to determine a financial position comprises to identify a risk associated with the customer.

Example 24 includes the subject matter of any of Examples 1-23, and wherein to identify a risk comprises to determine a likelihood of an inability of the customer to pay according to contractual terms of one or more financial products of the financial institution.

Example 25 includes the subject matter of any of Examples 1-24, and wherein the circuitry is further configured to determine a remedial action to mitigate the risk.

Example 26 includes the subject matter of any of Examples 1-25, and wherein to determine the remedial action comprises to determine target contractual terms for one or more financial products to mitigate the risk.

Example 27 includes the subject matter of any of Examples 1-26, and wherein to provide a user interface comprises to present decision data indicative of whether the customer should be approved for a loan and an amount of money the customer should be approved to borrow.

Example 28 includes the subject matter of any of Examples 1-27, and wherein to provide a user interface comprises to present decision data indicative of whether the customer should be approved for credit and an amount of credit the customer should be approved for.

Example 29 includes the subject matter of any of Examples 1-28, and wherein to provide a user interface comprises to present data indicative of a risk of late payment or default for one or more financial products of the financial institution.

Example 30 includes the subject matter of any of Examples 1-29, and wherein to provide a user interface comprises to present data indicative of a personalized offering of a financial product as a function of the customer financial position.

Example 31 includes the subject matter of any of Examples 1-30, and wherein to provide data indicative of a personalized offering comprises to present, as a function of the customer financial position, a personalized offer based on one or more of a determined behavior of the customer, a determined risk associated with the customer, or a determined amount approved for a loan or credit for the customer.

Example 32 includes the subject matter of any of Examples 1-31, and wherein to provide a user interface comprises to provide a graphical representation of data associated with the financial position in the user interface.

Example 33 includes the subject matter of any of Examples 1-32, and wherein the circuitry is further configured to present data indicative of transactions associated with financial accounts of one or more customers over one or more time periods; and adjust the presented data as a function of user input data provided through the user interface, including adjusting a time period or one or more financial products represented in the presented data.

Example 34 includes a method comprising obtaining, by a compute device and by aggregating multiple data streams of an event streaming system, financial status data indicative of balances and transactions associated with financial accounts of a customer of a financial institution; determining, by the compute device and based on the obtained financial status data, a financial position indicative of a consolidation of the financial status data for the customer of the financial institution; and providing, by the compute device, a user interface indicative of the financial position of the customer.

Example 35 includes the subject matter of Example 34, and wherein obtaining financial status data comprises obtaining financial status data in real time.

Example 36 includes the subject matter of any of Examples 34 and 35, and wherein obtaining financial status data comprises aggregating data streams indicative of deposits, withdrawals, and balances associated with one or more of the financial accounts of the customer.

Example 37 includes the subject matter of any of Examples 34-36, and wherein obtaining financial status data comprises obtaining data indicative of contractual terms associated with one or more of the financial accounts.

Example 38 includes the subject matter of any of Examples 34-37, and wherein obtaining financial status data comprises aggregating data streams pertaining to one or more deposit accounts of the customer.

Example 39 includes the subject matter of any of Examples 34-38, and wherein obtaining financial status data comprises aggregating data streams pertaining to one or more checking accounts or savings accounts of the customer.

Example 40 includes the subject matter of any of Examples 34-39, and wherein obtaining financial status data comprises aggregating data streams pertaining to one or more investment accounts of the customer.

Example 41 includes the subject matter of any of Examples 34-40, and wherein obtaining financial status data comprises aggregating data streams pertaining to one or more certificates of deposit or retirement accounts of the customer.

Example 42 includes the subject matter of any of Examples 34-41, and wherein obtaining financial status data comprises aggregating data streams pertaining to one or more lending products of the financial institution.

Example 43 includes the subject matter of any of Examples 34-42, and wherein obtaining financial status data comprises aggregating data streams pertaining to one or more credit products of the financial institution.

Example 44 includes the subject matter of any of Examples 34-43, and wherein obtaining financial status data comprises aggregating data streams associated with banking industry architecture network codes.

Example 45 includes the subject matter of any of Examples 34-44, and wherein obtaining financial status data comprises obtaining historical data pertaining to financial products of the financial institution.

Example 46 includes the subject matter of any of Examples 34-45, and wherein determining a financial position comprises determining liquid assets of the customer.

Example 47 includes the subject matter of any of Examples 34-46, and wherein determining a financial position comprises determining one or more behaviors of the customer based on the obtained financial status data.

Example 48 includes the subject matter of any of Examples 34-47, and wherein determining one or more behaviors comprises determining one or more of saving patterns, spending patterns, or investment patterns of the customer.

Example 49 includes the subject matter of any of Examples 34-48, and wherein determining a financial position comprises determining a performance of one or more investment accounts of the customer.

Example 50 includes the subject matter of any of Examples 34-49, and wherein determining a financial position comprises determining a maturity of one or more investments associated with one or more investment accounts of the customer.

Example 51 includes the subject matter of any of Examples 34-50, and wherein determining a financial position comprises determining average balances across financial accounts of the customer over multiple time periods to obtain a profile indicative of a financial stability of the customer.

Example 52 includes the subject matter of any of Examples 34-51, and wherein obtaining a profile indicative of the financial stability comprises determining a rate of change in balances across the financial accounts of the customer.

Example 53 includes the subject matter of any of Examples 34-52, and wherein obtaining a profile indicative of the financial stability comprises determining a trajectory of balances across the financial accounts of the customer.

Example 54 includes the subject matter of any of Examples 34-53, and wherein determining a financial position comprises determining a creditworthiness of the customer.

Example 55 includes the subject matter of any of Examples 34-54, and wherein determining the creditworthiness of the customer comprises determining the creditworthiness as a function of outstanding balances, payment histories, and contractual terms of financial products used by the customer.

Example 56 includes the subject matter of any of Examples 34-55, and wherein determining a financial position comprises identifying a risk associated with the customer.

Example 57 includes the subject matter of any of Examples 34-56, and wherein identifying a risk comprises determining a likelihood of an inability of the customer to pay according to contractual terms of one or more financial products of the financial institution.

Example 58 includes the subject matter of any of Examples 34-57, and further including determining, by the compute device, a remedial action to mitigate the risk.

Example 59 includes the subject matter of any of Examples 34-58, and wherein determining the remedial action comprises determining target contractual terms for one or more financial products to mitigate the risk.

Example 60 includes the subject matter of any of Examples 34-59, and wherein providing a user interface comprises presenting decision data indicative of whether the customer should be approved for a loan and an amount of money the customer should be approved to borrow.

Example 61 includes the subject matter of any of Examples 34-60, and wherein providing a user interface comprises presenting decision data indicative of whether the customer should be approved for credit and an amount of credit the customer should be approved for.

Example 62 includes the subject matter of any of Examples 34-61, and wherein providing a user interface comprises presenting data indicative of a risk of late payment or default for one or more financial products of the financial institution.

Example 63 includes the subject matter of any of Examples 34-62, and wherein providing a user interface comprises presenting data indicative of a personalized offering of a financial product as a function of the customer financial position.

Example 64 includes the subject matter of any of Examples 34-63, and wherein providing data indicative of a personalized offering comprises presenting, as a function of the customer financial position, a personalized offer based on one or more of a determined behavior of the customer, a determined risk associated with the customer, or a determined amount approved for a loan or credit for the customer.

Example 65 includes the subject matter of any of Examples 34-64, and wherein providing a user interface comprises providing a graphical representation of data associated with the financial position in the user interface.

Example 66 includes the subject matter of any of Examples 34-65, and further including presenting, by the compute device, data indicative of transactions associated with financial accounts of one or more customers over one or more time periods; and adjusting, by the compute device, the presented data as a function of user input data provided through the user interface, including adjusting a time period or one or more financial products represented in the presented data.

Example 67 includes one or more machine-readable storage media comprising a plurality of instructions stored thereon that, in response to being executed, cause a compute device to obtain, by aggregating multiple data streams of an event streaming system, financial status data indicative of balances and transactions associated with financial accounts of a customer of a financial institution; determine, based on the obtained financial status data, a financial position indicative of a consolidation of the financial status data for the customer of the financial institution; and provide a user interface indicative of the financial position of the customer.

Example 68 includes the subject matter of Example 67, and wherein to obtain financial status data comprises to obtain financial status data in real time.

Example 69 includes the subject matter of any of Examples 67 and 68, and wherein to obtain financial status data comprises to aggregate data streams indicative of deposits, withdrawals, and balances associated with one or more of the financial accounts of the customer.

Example 70 includes the subject matter of any of Examples 67-69, and wherein to obtain financial status data comprises to obtain data indicative of contractual terms associated with one or more of the financial accounts.

Example 71 includes the subject matter of any of Examples 67-70, and wherein to obtain financial status data comprises to aggregate data streams pertaining to one or more deposit accounts of the customer.

Example 72 includes the subject matter of any of Examples 67-71, and wherein to obtain financial status data comprises to aggregate data streams pertaining to one or more checking accounts or savings accounts of the customer.

Example 73 includes the subject matter of any of Examples 67-72, and wherein to obtain financial status data comprises to aggregate data streams pertaining to one or more investment accounts of the customer.

Example 74 includes the subject matter of any of Examples 67-73, and wherein to obtain financial status data comprises to aggregate data streams pertaining to one or more certificates of deposit or retirement accounts of the customer.

Example 75 includes the subject matter of any of Examples 67-74, and wherein to obtain financial status data comprises to aggregate data streams pertaining to one or more lending products of the financial institution.

Example 76 includes the subject matter of any of Examples 67-75, and wherein to obtain financial status data comprises to aggregate data streams pertaining to one or more credit products of the financial institution.

Example 77 includes the subject matter of any of Examples 67-76, and wherein to obtain financial status data comprises to aggregate data streams associated with banking industry architecture network codes.

Example 78 includes the subject matter of any of Examples 67-77, and wherein to obtain financial status data comprises to obtain historical data pertaining to financial products of the financial institution.

Example 79 includes the subject matter of any of Examples 67-78, and wherein to determine a financial position comprises to determine liquid assets of the customer.

Example 80 includes the subject matter of any of Examples 67-79, and wherein to determine a financial position comprises to determine one or more behaviors of the customer based on the obtained financial status data.

Example 81 includes the subject matter of any of Examples 67-80, and wherein to determine one or more behaviors comprises to determine one or more of saving patterns, spending patterns, or investment patterns of the customer.

Example 82 includes the subject matter of any of Examples 67-81, and wherein to determine a financial position comprises to determine a performance of one or more investment accounts of the customer.

Example 83 includes the subject matter of any of Examples 67-82, and wherein to determine a financial position comprises to determine a maturity of one or more investments associated with one or more investment accounts of the customer.

Example 84 includes the subject matter of any of Examples 67-83, and wherein to determine a financial position comprises to determine average balances across financial accounts of the customer over multiple time periods to obtain a profile indicative of a financial stability of the customer.

Example 85 includes the subject matter of any of Examples 67-84, and wherein to obtain a profile indicative of the financial stability comprises to determine a rate of change in balances across the financial accounts of the customer.

Example 86 includes the subject matter of any of Examples 67-85, and wherein to obtain a profile indicative of the financial stability comprises to determine a trajectory of balances across the financial accounts of the customer.

Example 87 includes the subject matter of any of Examples 67-86, and wherein to determine a financial position comprises to determine a creditworthiness of the customer.

Example 88 includes the subject matter of any of Examples 67-87, and wherein to determine the creditworthiness of the customer comprises to determine the creditworthiness as a function of outstanding balances, payment histories, and contractual terms of financial products used by the customer.

Example 89 includes the subject matter of any of Examples 67-88, and wherein to determine a financial position comprises to identify a risk associated with the customer.

Example 90 includes the subject matter of any of Examples 67-89, and wherein to identify a risk comprises to determine a likelihood of an inability of the customer to pay according to contractual terms of one or more financial products of the financial institution.

Example 91 includes the subject matter of any of Examples 67-90, and wherein the instructions additionally cause the compute device to determine a remedial action to mitigate the risk.

Example 92 includes the subject matter of any of Examples 67-91, and wherein to determine the remedial action comprises to determine target contractual terms for one or more financial products to mitigate the risk.

Example 93 includes the subject matter of any of Examples 67-92, and wherein to provide a user interface comprises to present decision data indicative of whether the customer should be approved for a loan and an amount of money the customer should be approved to borrow.

Example 94 includes the subject matter of any of Examples 67-93, and wherein to provide a user interface comprises to present decision data indicative of whether the customer should be approved for credit and an amount of credit the customer should be approved for.

Example 95 includes the subject matter of any of Examples 67-94, and wherein to provide a user interface comprises to present data indicative of a risk of late payment or default for one or more financial products of the financial institution.

Example 96 includes the subject matter of any of Examples 67-95, and wherein to provide a user interface comprises to present data indicative of a personalized offering of a financial product as a function of the customer financial position.

Example 97 includes the subject matter of any of Examples 67-96, and wherein to provide data indicative of a personalized offering comprises to present, as a function of the customer financial position, a personalized offer based on one or more of a determined behavior of the customer, a determined risk associated with the customer, or a determined amount approved for a loan or credit for the customer.

Example 98 includes the subject matter of any of Examples 67-97, and wherein to provide a user interface comprises to provide a graphical representation of data associated with the financial position in the user interface.

Example 99 includes the subject matter of any of Examples 67-98, and wherein the instructions additionally cause the compute device to present data indicative of transactions associated with financial accounts of one or more customers over one or more time periods; and adjust the presented data as a function of user input data provided through the user interface, including adjusting a time period or one or more financial products represented in the presented data.

1. A compute device comprising:
circuitry configured to:
obtain, by aggregating multiple data streams of an event streaming system, financial status data indicative of balances and transactions associated with financial accounts of a customer of a financial institution;
determine, based on the obtained financial status data, a financial position indicative of a consolidation of the financial status data for the customer of the financial institution; and
provide a user interface indicative of the financial position of the customer.

2. The compute device of claim 1, wherein to obtain financial status data comprises to aggregate data streams indicative of deposits, withdrawals, and balances associated with one or more of the financial accounts of the customer.

3. The compute device of claim 2, wherein to obtain financial status data comprises to aggregate data streams pertaining one or more of: (i) one or more deposit accounts of the customer; (ii) one or more checking accounts or savings accounts of the customer; (iii) one or more investment accounts of the customer; (iv) one or more certificates of deposit or retirement accounts of the customer; (v) one or more lending products of the financial institution; and/or (vi) one or more credit products of the financial institution.

4. The compute device of claim 1, wherein to obtain financial status data comprises to aggregate data streams associated with banking industry architecture network codes.

5. The compute device of claim 1, wherein to determine a financial position comprises to determine average balances across financial accounts of the customer over multiple time periods to obtain a profile indicative of a financial stability of the customer.

6. The compute device of claim 5, wherein to obtain a profile indicative of the financial stability comprises to determine a rate of change in balances across the financial accounts of the customer.

7. The compute device of claim 5, wherein to obtain a profile indicative of the financial stability comprises to determine a trajectory of balances across the financial accounts of the customer.

8. The compute device of claim 1, wherein to determine a financial position comprises to identify a risk associated with the customer by determining a likelihood of an inability of the customer to pay according to contractual terms of one or more financial products of the financial institution.

9. The compute device of claim 8, wherein the circuitry is further configured to determine a remedial action to mitigate the risk comprising determining target contractual terms for one or more financial products to mitigate the risk.

10. The compute device of claim 1, wherein to provide a user interface comprises to present decision data indicative of whether the customer should be approved for a loan and an amount of money the customer should be approved to borrow and an amount of credit the customer should be approved for.

11. The compute device of claim 1, wherein to provide a user interface comprises to present data indicative of a risk of late payment or default for one or more financial products of the financial institution.

12. The compute device of claim 1, wherein to provide a user interface comprises to present data indicative of a personalized offering of a financial product as a function of the customer financial position.

13. The compute device of claim 12, wherein to provide data indicative of a personalized offering comprises to present, as a function of the customer financial position, a personalized offer based on one or more of a determined behavior of the customer, a determined risk associated with the customer, or a determined amount approved for a loan or credit for the customer.

14. A method comprising:
obtaining, by aggregating multiple data streams of an event streaming system, financial status data indicative of balances and transactions associated with financial accounts of a customer of a financial institution;
determining, based on the obtained financial status data, a financial position indicative of a consolidation of the financial status data for the customer of the financial institution; and
providing a user interface indicative of the financial position of the customer.

15. The method of claim 14, wherein obtaining financial status data comprises aggregating data streams indicative of deposits, withdrawals, and balances associated with one or more of the financial accounts of the customer.

16. The method of claim 14, wherein obtaining financial status data comprises aggregating data streams pertaining one or more of: (i) one or more deposit accounts of the customer; (ii) one or more checking accounts or savings accounts of the customer; (iii) one or more investment accounts of the customer; (iv) one or more certificates of deposit or retirement accounts of the customer; (v) one or more lending products of the financial institution; and/or (vi) one or more credit products of the financial institution.

17. The method of claim 14, wherein obtaining financial status data comprises aggregating data streams associated with banking industry architecture network codes.

18. The method of claim 14, wherein determining a financial position comprises determining average balances across financial accounts of the customer over multiple time periods to obtain a profile indicative of a financial stability of the customer.

19. The method of claim 18, wherein obtaining a profile indicative of the financial stability comprises determining a rate of change in balances across the financial accounts of the customer.

20. The method of claim 18, wherein obtaining a profile indicative of the financial stability comprises determining a trajectory of balances across the financial accounts of the customer.

21. The method of claim 14, wherein determining a financial position comprises identifying a risk associated with the customer by determining a likelihood of an inability of the customer to pay according to contractual terms of one or more financial products of the financial institution.

22. The method of claim 21, further comprising determining a remedial action to mitigate the risk by determining target contractual terms for one or more financial products to mitigate the risk.

23. The method of claim 14, wherein providing a user interface comprises presenting decision data indicative of whether the customer should be approved for a loan and an amount of money the customer should be approved to borrow and an amount of credit the customer should be approved for.

24. The method of claim 14, wherein providing a user interface comprises presenting data indicative of a risk of late payment or default for one or more financial products of the financial institution.

25. The method of claim 14, wherein providing a user interface comprises presenting data indicative of a personalized offering of a financial product as a function of the customer financial position.

26. The method of claim 25, wherein providing data indicative of a personalized offering comprises presenting, as a function of the customer financial position, a personalized offer based on one or more of a determined behavior of the customer, a determined risk associated with the customer, or a determined amount approved for a loan or credit for the customer.
